(19) United States
(12) Patent Application Publication
(10) Pub. No.: US 2013/0235387 A1
(43) Pub. Date: Sep. 12, 2013

(54) THREE-DIMENSIONAL MEASURING DEVICE AND METHOD

(71) Applicant: SAMSUNG ELECTRO-MECHANICS CO., LTD., Suwon-si (KR)

(72) Inventor: Taeg Gyum KIM, Suwon (KR)

(73) Assignee: Samsung Electro-Mechanics Co., Ltd., Suwon-si (KR)

(21) Appl. No.: 13/785,638

(22) Filed: Mar. 5, 2013

(30) Foreign Application Priority Data
Mar. 9, 2012 (KR) 10-2012-0024390

(51) Int. Cl. G01B 11/24; G01N 21/956

(52) U.S. Cl. CPC G01B 11/24; G01N 21/956
USPC 356/601

(57) ABSTRACT

Disclosed herein is a three-dimensional (3D) measuring device and method. The 3D measuring device includes a light source emitting a laser beam, a focal point adjusting device adjusting a focal position of the laser beam, a rotating reflection mirror reflecting the laser beam of which the focal position is adjusted by the focal point adjusting device, a scanning lens disposed on a route of the laser beam so as to scan a measuring target with the laser beam reflected by the rotating reflection mirror, a condenser lens condensing the laser beam reflected on the measuring target, and at least one detection unit receiving the laser beam condensed on the condenser lens to thereby detect a laser beam signal.

### CROSS REFERENCE(S) TO RELATED APPLICATIONS

This application claims the benefit under 35 U.S.C. Section 119 of Korean Patent Application Serial No. 10-2012-0024390, entitled “Three-Dimensional Measuring Device and Method” filed on Mar. 9, 2012, which is hereby incorporated by reference in its entirety into this application.

### BACKGROUND OF THE INVENTION

1. Technical Field

The present invention relates to a three-dimensional (3D) measuring device and method, and more particularly, to a 3D measuring device and method which may measure a defect and a height of a hole of a metal mask for a solder ball by scanning the metal mask for a solder ball using a laser.

2. Description of the Related Art

In recent years, the trend in the electronic industry is to manufacture lighter, smaller, faster, multi-functional, higher performance, and higher reliability products while at low cost. Accordingly, a Ball Grid Array (BGA) bonding scheme is frequently used in order to mount a plurality of chip elements on a limited substrate region, and denotes a scheme in which a plurality of pads are disposed on a chip bottom surface, and the plurality of chip elements are directly mounted on a bonding pad of a circuit board using a solder ball.

In such BGA bonding scheme, the solder ball is formed in a manner such that a metal mask on which a hole is formed so as to correspond to the bonding pad of the circuit board is put on the circuit board, the hole of the metal mask is filled with paste, and the metal mask is removed to be subjected to a reflow processing. In this instance, the hole of the metal mask to be used is required to be formed to have the exact same depth corresponding to the bonding pad of the circuit board.

Accordingly, there is a need for a device that can measure and inspect whether a defect of the metal mask is present.

In general, as a method for measuring whether the defect of the metal mask is present, a laser beam is condensed on a surface of the metal mask, light scattered from a place where the laser beam is condensed is received, and defects such as foreign matter, deformation, and the like are detected depending on intensity of the scattered light; however, there is a problem in that it is difficult to detect defects such as a difference in the depths of the metal mask holes, and the like.

Meanwhile, a three-dimensional (3D) measuring device for measuring a height of an object has been used. In the 3D measuring device in the prior art, a method of detecting the height of the object by detecting several two-dimensional (2D) images of the object in various directions, and a method of measuring a position displacement using a laser triangulation measuring method have been used; however, the 3D measuring device using these measuring methods has problems, such as difficulties in measuring a height of a hole in which a reference point of each of a bottom surface and an upper end which are references of the height is not constant.

### SUMMARY OF THE INVENTION

An object of the present invention is to provide a three-dimensional (3D) measuring device and method which may detect a defect of a metal mask, and measure a 3D shape.

According to an embodiment of the present invention, there is provided a three-dimensional (3D) measuring device, including: a light source emitting a laser beam; a focal point adjusting device adjusting a focal position of the laser beam; a rotating reflection mirror reflecting the laser beam of which the focal position is adjusted by the focal point adjusting device; a scanning lens disposed on a route of the laser beam so as to scan a measuring target with the laser beam reflected by the rotating reflection mirror; a condenser lens condensing the laser beam reflected or scattered on the measuring target; and at least one detection unit receiving the laser beam condensed on the condenser lens to thereby detect a laser beam signal.

Here, the light source may include a first light source and a second light source which emit laser beams having mutually different wavelengths.

In addition, the focal point adjusting device may include a first focal point adjusting device and a second focal point adjusting device which align the focal position of the laser beam with one of an upper end portion and a lower end portion of the measuring target.

Further, the focal point adjusting device may adjust the focal position of the laser beam in accordance with the laser beam signal detected by the detection unit.

Further, the rotating reflection mirror may be formed of one of a galvanometer mirror and a polygon mirror.

Meanwhile, the 3D measuring device may further include a half reflection mirror selectively transmitting or reflecting the laser beam in accordance with a wavelength of the laser beam.

Here, the half reflection mirror may include a first half reflection mirror which is formed between the focal point adjusting device and the rotating reflection mirror, and a second half reflection mirror which is formed between the condenser lens and the detection unit.

In addition, the half reflection mirror may be formed of one of a dichroic mirror and a dichroic filter.

Further, the laser beam reflected by the rotating reflection mirror may be made to scan a measurement surface of the measuring target while being inclined at a predetermined angle.

Meanwhile, the scanning lens may be an F-theta lens.

In addition, the detection unit may include a first detection unit and a second detection unit which receive and detect laser beams having mutually different wavelengths.

In addition, the laser beam signal may be image information of the measuring target and illuminance information of the reflected laser beam.

Further, the 3D measuring device may further include a stage moving the measuring target.

According to another embodiment of the present invention, there is provided a 3D measuring method, using a 3D measuring device which includes a light source, a focal point adjusting device, a rotating reflection mirror, a scanning lens, a condenser lens, and a detection unit, including: reflecting a laser beam emitted from the light source using the rotating reflection mirror, and irradiating a measurement surface of the measuring target with the reflected laser beam while the laser beam is inclined at a predetermined scanning angle; condensing the laser beam reflected or scattered from the measuring target into the condenser lens to receive the condensed laser beam by the detection unit; and detecting a laser beam signal from the received laser beam.

Here, in the reflecting of the laser beam, the light source may include a first light source and a second light source which have mutually different wavelengths, and the first light source and the second light source may align a focal position with an upper end surface or a lower end surface of the measuring target using a focal point adjusting device which is respectively formed in the first light source and the second light source.

In addition, in the condensing of the laser beam, the detection unit may include a first detection unit and a second detection unit, and the first detection unit and the second detection unit may receive laser beams having mutually different laser beams.

In addition, the 3D measuring method may further include measuring a height of the measuring target through the laser beam signal and a scanning angle of the laser beam irradiated to the measuring target after the detecting of the laser beam signal.

Further, the 3D measuring method may further include adjusting a focal position of the laser beam in accordance with the laser beam signal after the detecting of the laser beam signal.

### BRIEF DESCRIPTION OF THE DRAWINGS

FIG. 1 is a schematic diagram showing a three-dimensional (3D) measuring device according to an embodiment of the present invention;

FIG. 2 is a schematic diagram showing a 3D measuring device according to another embodiment of the present invention;

FIG. 3 is a schematic flowchart showing a 3D measuring method using a 3D measuring device according to an embodiment of the present invention; and

FIG. 4 is a graph showing illuminance detected through a 3D measuring device according to an embodiment of the present invention.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, a detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

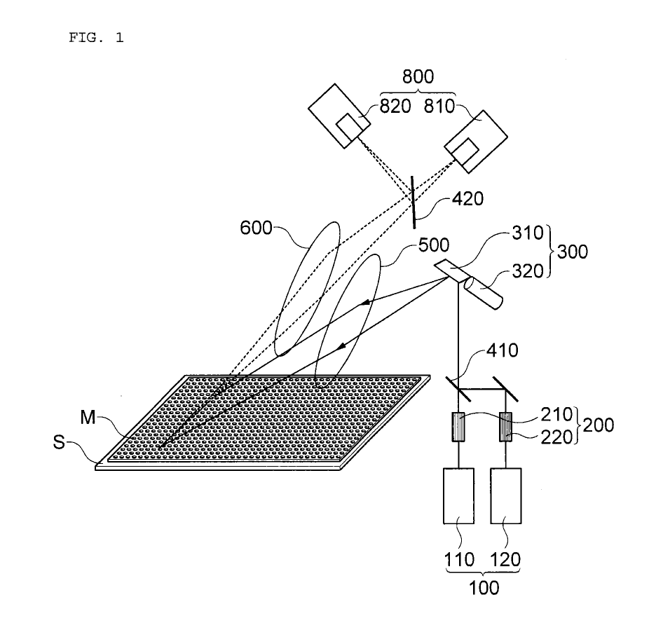

FIG. 1 is a schematic diagram showing a three-dimensional (3D) measuring device according to an embodiment of the present invention.

As shown in FIG. 1, the 3D measuring device according to an embodiment of the present invention may include a light source 100 emitting a laser beam, a focal point adjusting device 200 adjusting a focal position of the laser beam, a rotating reflection mirror 300 reflecting the laser beam of which the focal position is adjusted by the focal point adjusting device 200, a scanning lens 500 disposed on a route of the laser beam so as to scan a measuring target with the laser beam reflected by the rotating reflection mirror 300, a condenser lens 600 condensing the laser beam reflected or scattered on the measuring target, and at least one detection unit 800 receiving the laser beam condensed on the condenser lens 600 to thereby detect a laser beam signal.

Here, the measuring target that is a target of 3D measuring may be a metal mask (M) for forming a solder ball, and the metal mask (M) may be disposed on a stage (S). In this instance, the stage (S) may be formed to be moved in a direction in which measuring is performed on the metal mask (M) disposed on an upper surface of the stage (S).

As the light source 100 that emits a laser beam, any laser that can serve for the purpose of 3D measuring may be used, and for example, YAG lasers, Femtosecond lasers, and the like may be used.

Here, the light source 100 may include a first light source 110 and a second light source 120, and the first light source 110 and the second light source 120 may emit laser beams having mutually different wavelengths.

In this manner, a focal position, a size, or the like of the laser beam emitted from the light source 100 may be adjusted by the focal point adjusting device 200.

The focal point adjusting device 200 may be used for adjusting the focal position, the size, or the like of the laser beam emitted from the light source 100, and composed of at least two lenses.

In this instance, the lenses constituting the focal point adjusting device 200 may be composed of convex lenses, concave lenses, or a combination thereof, and the focal position, the size, or the like of the laser beam which transmits may be adjusted by adjusting an interval between the composed lenses. In addition, an example in which the focal point adjusting device 200 of the present invention uses two lenses has been described; however, the present invention is not limited thereto, and the number of lenses and a combination of the types of lenses may be changed in response to the designer's intent.

In addition, the focal point adjusting device 200 may include a first focal point adjusting device 210 and a second focal point adjusting device 220, and may be disposed so as to respectively adjust the laser beams emitted from the first light source 110 and the second light source 120.

That is, the first focal point adjusting device 210 may adjust a focal position, a size, or the like of the laser beam which is emitted from the first light source 110, and the second focal point adjusting device 220 may adjust a focal position, a size, or the like of the laser beam which is emitted from the second light source 120. For example, the focal position of the laser beam emitted from the first light source 110 may be aligned with an upper end portion of the metal mask (M) by the first focal point adjusting device 210, and the focal position of the laser beam emitted from the second light source 120 may be aligned with an inner lower end portion of a through hole formed on the metal mask (M) by the second focal point adjusting device 220.

In addition, the focal position of each of the first focal point adjusting device 210 and the second focal point adjusting device 220 may be changed depending on a designer, and as opposed to the above focal position thereof, the focal position of the laser beam may be aligned with the inner lower end portion of the through hole formed on the metal mask (M) by the first focal point adjusting device 210, and the focal position of the laser beam may be aligned with the upper end portion of the metal mask (M) by the second focal point adjusting device 220.

Here, using the focal point adjusting device 200, the focal position, the size of the laser beam, or the like may be adjusted in accordance with a laser beam signal that is detected by the detection unit 800 which will be described below by the focal point adjusting device 200.

Accordingly, the laser beams having mutually different wavelengths which are emitted from two light sources 100 are respectively aligned with the upper end portion and the lower end portion of the metal mask (M) using the focal point adjusting device 200 that is respectively disposed, and therefore, a 3D shape may be more accurately measured in comparison with a case of using a single light source.

The laser beam of which the focal position is adjusted by the focal point adjusting device 200 may be reflected to the metal mask (M) by the rotating reflection mirror 300.

Here, a first half reflection mirror 410 may be provided between the focal point adjusting device 200 and the rotating reflection mirror 300.

The first half reflection mirror 410 may selectively transmit or reflect the laser beam in accordance with a wavelength of the laser beam, and may be formed of one of a dichroic mirror and a dichroic filter.

In addition, the first half reflection mirror 410 may transmit and reflect each of the laser beams, which are emitted from the first light source 110 and the second light source 120 and of which the focal position is adjusted, in accordance with the wavelength of the laser beam.

Here, transmittance and reflectance of the laser beam of the first half reflection mirror 410 may be appropriately adjusted in accordance with an angle formed by the laser beam and the first half reflection mirror 410, a thickness of the first half reflection mirror 410, or the like.

In this instance, the first half reflection mirror 410 is installed on a route of the laser beam at 45 degrees, so that the laser beam transmitted by the first half reflection mirror 410 is made to scan on a straight route, and the laser beam reflected by the first half reflection mirror 410 is reflected at 90 degrees causing a change in the route of the laser beam.

That is, the laser beams which are emitted from the first light source 110 and the second light source 120 to different optical routes are transmitted or reflected by the first half reflection mirror 410 causing the change in the route of the laser beam in the same direction, and therefore the laser beams reach the rotating reflection mirror 300.

For example, the laser beam emitted from the first light source 110 may be transmitted through the first half reflection mirror 410 to thereby reach the rotating reflection mirror 300, and the laser beam emitted from the second light source 120 may be reflected by the first half reflection mirror 410 to thereby reach the rotating reflection mirror 300.

The rotating reflection mirror 300 reflects the laser beam irradiated from the first half reflection mirror 410 to thereby scan the metal mask (M), and the laser beam reflected by the rotating reflection mirror 300 may be formed on one side of the metal mask (M) so as to be made to scan a measurement surface of the metal mask (M) while being inclined at a predetermined angle. Here, a scanning angle (θ) between the measurement surface of the metal mask (M) and the laser beam that is made to scan the metal mask (M) by the rotating reflection mirror 300 may be formed to be constant, and a range of the scanning angle (θ) is preferably formed to have 20 degrees to 70 degrees.

In addition, the rotating reflection mirror 300 may be formed of a galvanometer mirror including a mirror unit 310 reflecting a laser beam and a driving unit 320 rotating the mirror unit 310.

That is, in the rotating reflection mirror 300, the mirror unit 310 is rotated in one direction or a right and left direction by the driving unit 320 such as a motor, or the like, so that the route of the laser beam is changed due to reflection of the laser beam incident into the mirror unit 310. For example, the laser beam reflected by the mirror unit 310 is made to scan one side of the metal mask (M), and to scan the other side of the metal mask (M) as the mirror unit 310 is rotated. In this instance, the mirror unit 310 is continuously rotated, and therefore, the laser beam reflected by the mirror unit 310 is continuously made to scan from one side of the metal mask (M) to the other side thereof.

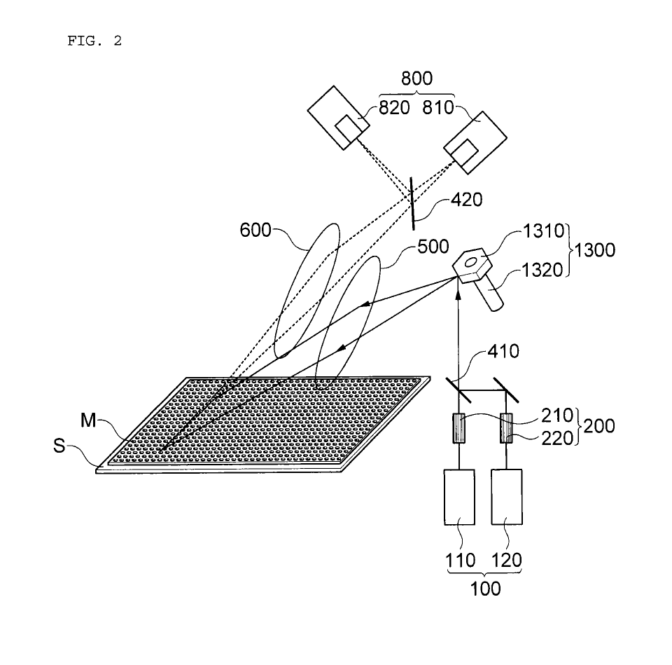

Meanwhile, as shown in FIG. 2, the rotating reflection mirror 300 may be formed of a polygon mirror 1300 that is composed of a regular polygonal prismatic column having at least six sides, instead of the galvanometer mirror. The polygon mirror unit 1300 may include a mirror 1310 that is formed of a six-sided regular polygonal prismatic column, and a motor 1320 that rotates the mirror unit 1310. The polygon mirror 1300 may scan, in one direction, the metal mask (M) with the laser beam which is rotated by the motor 1320 to be made incident. In this instance, the mirror unit 1310 may be formed of a polygonal prismatic column having the different number of sides other than the six sides.

The scanning lens 500 may be formed on a route of the laser beam so that a focal point of the laser beam reflected by the rotating reflection mirror 300 is adjusted to be constant, and the laser beam is made to scan the metal mask (M).

In this instance, the scanning lens 500 is preferably formed of an F-theta lens. The F-theta lens may maintain a scanning direction, an incident angle, and a focal point of the laser beam to be constant, and thereby more accurately measure the metal mask (M).

The laser beam which is transmitted through the scanning lens 500 is made to scan the metal mask (M), and reflected or scattered depending on a shape of a surface of the metal mask (M). Here, the laser beam which is reflected or scattered may be condensed on the condenser lens 600 to be received by the detection unit 800.

In this instance, a second half reflection mirror 420 is formed between the condenser lens 600 and the detection unit 800 to thereby selectively transmit or reflect the laser beam condensed by the condenser lens 600 in accordance with a wavelength of the laser beam.

Here, the second half reflection mirror 420 may be formed of one of the dichroic mirror and the dichroic filter in the same manner as that of the first half reflection mirror 410 as described above, and may be installed on the route of the laser beam at 45 degrees so that the transmitted laser beam is made to scan on a straight route, and the reflected laser beam is reflected at 90 degrees causing a change in the route of the laser beam.

The detection unit 800 receives the laser beam condensed by the condenser lens 600 to thereby detect a laser beam signal, and may include a first detection unit 810 and a second detection unit 820 which receive laser beams having mutually different wavelengths to thereby detect the laser beam signal.

In this instance, the first detection unit 810 and the second detection unit 820 may receive and detect a laser beam having a wavelength corresponding to the wavelength of the laser beam that is emitted from each of the first light source 110 and the second light source 120.

Accordingly, the laser beam condensed by the condenser lens 600 is transmitted or reflected through or on the second half reflection mirror 420 in accordance with a wavelength of the laser beam, and spectrally split into two laser beams having mutually different wavelengths to be received by the first detection unit 810 or the second detection unit 820. As a result, the first detection unit 810 and the second detection unit 820 may receive the laser beam having the wavelength corresponding to each of the laser beams which are emitted from the first light source 110 and the second light source 120.

For example, the laser beam that is emitted from the first light source 110 and is made to scan the metal mask (M) may be transmitted through the second half reflection mirror 420 to thereby be received by the first detection unit 810, and the laser beam that is emitted from the second light source 120 and is made to scan the metal mask (M) may be reflected on the second half reflection mirror 420 to thereby be received by the second detection unit 820.

In addition, the detection unit 800 may function to convert the received laser beam into a laser beam signal that is an electrical signal, and to analyze the laser beam signal. In this instance, the laser beam signal may be image information obtained by photographing the measurement surface of the metal mask (M) and luminance information of the laser beam reflected on the metal mask (M), so that deformation or positioning failure of the hole of the metal mask (M) such as distortion of the hole may be detected using the detected image information, and foreign matter on the surface of the metal mask (M) or a hole height of the metal mask (M) may be measured using the illuminance information.

Hereinafter, a 3D measuring method using the 3D measuring device according to an embodiment of the present invention will be described in detail.

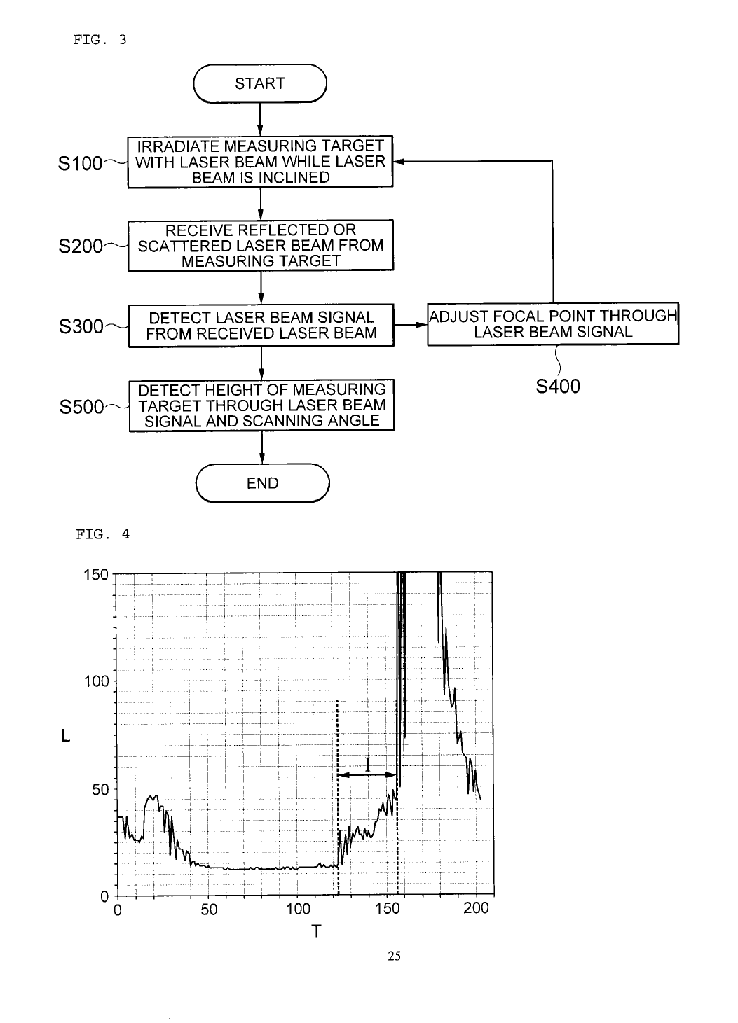

FIG. 3 is a schematic flowchart showing a 3D measuring method using a 3D measuring device according to an embodiment of the present invention, and FIG. 4 is a graph showing illuminance detected through a 3D measuring device according to an embodiment of the present invention.

As shown in FIGS. 3 and 4, the 3D measuring method using the 3D measuring device according to an embodiment of the present invention which includes the light source 100, the focal point adjusting device 200, the rotating reflection mirror 300, the scanning lens 500, the condenser lens 600, and the detection unit 800 may include irradiating a measuring target with a laser beam while the laser beam is inclined S100, receiving the laser beam that is reflected or scattered from the measuring target S200, and detecting a laser beam signal from the received laser beam S300.

In this instance, the measuring target may be the metal mask (M) for forming a solder ball, and disposed on the stage (S) to be moved in a direction in which measuring is performed.

First, in step S100, the measuring target may be irradiated with a laser beam emitted from the light source 100 while the laser beam is inclined at a predetermined angle.

Here, the light source 100 may include a first light source 110 and a second light source 120 to emit the laser beams having mutually different wavelengths, and a focal position of the emitted laser beams is adjusted to be respectively aligned with an upper end portion of the metal mask (M) and an inner lower end portion of the hole of the metal mask (M) through the first focal point adjusting device 210 and the second focal point adjusting device 220.

Thereafter, a route of the laser beam of which the focal position is adjusted is changed in the same direction through the first half reflection mirror 410 so that the rotating reflection mirror 300 is irradiated with the laser beam, and the laser beam is reflected by the rotating reflection mirror 300 which is rotated to thereby be made to scan the metal mask (M).

In this instance, the laser beam which is made to scan the metal mask (M) is made to scan the measurement surface of the metal mask (M) while being inclined at a predetermined scanning angle (θ), and the focal position of the laser beam is adjusted to be constant using the scanning lens 500 so that the metal mask (M) is scanned with the laser beam.

Next, in step S200, the laser beam which is made to scan the metal mask (M) is reflected or scattered, and the reflected or scattered laser beam is condensed on the condenser lens 600 to thereby be received by the detection unit 800.

Here, the laser beam condensed using the condenser lens 600 is spectrally split into two laser beams having mutually different wavelengths using the second half reflection mirror 420 formed on a route of the laser beam between the condenser lens 600 and the detection unit 800, and received by the detection unit 800.

In this instance, the detection unit 800 includes a first detection unit 810 and a second detection unit 820, and receives laser beams having wavelengths corresponding to the wavelengths of the laser beams emitted from the first light source 110 and the second light source 120. Here, the laser beam which is emitted from the first light source 110 and reflected or scattered on the measurement surface of the metal mask (M) is transmitted through the second half reflection mirror 420 to thereby be received by the first detection unit 810, and the laser beam which is emitted from the second light source 120 and reflected or scattered on the measurement surface of the metal mask (M) is reflected on the second half reflection mirror 420 to thereby be received by the second detection unit 820.

Next, in step S300, a laser beam signal is detected from the received laser beam.

Here, the detection unit 800 converts the received laser beam into the laser beam signal that is an electrical signal, and analyzes the laser beam signal. In this instance, the laser beam signal may be image information obtained by photographing the measurement surface of the metal mask (M) and illuminance information of the laser beam reflected on the metal mask (M).

Here, the illuminance information relates to an amount of the laser beam which is detected by the detection unit 800 with respect to the laser beam reflected on the metal mask (M), and may indicate illuminance variation quantity with respect to a movement time of the metal mask (M) as shown in FIG. 4.

Next, in step S400, the focal position of the laser beam is adjusted by controlling the focal point adjusting device 200 in accordance with the detected laser beam signal.

Here, when deviation of the focal point is detected through the laser beam signal detected by the detection unit 800, a signal for adjusting the focal point is transmitted to the focal point adjusting device 200, and the focal point adjusting device 200 adjusts the focal point of the laser beam through the received signal.

In addition, in step S500, a height (H) of the hole of the metal mask (M) is measured using the laser beam signal and a scanning angle (θ) of the laser beam which is made to scan the metal mask (M).

Here, the height (H) of the hole of the metal mask (M) may be obtained through the following Equation 1.

H=I*1/cos θ [Equation 1]

In Equation 1, H denotes a height of the hole of the metal mask (M), I denotes a position difference of an upper end and a lower end of the detected hole of the metal mask (M), which is a difference between points where an amount of the laser beam in the illuminance information of FIG. 4 is dramatically changed, and θ denotes a scanning angle (θ) at which the laser beam is made to scan the measurement surface of the metal mask (M).

That is, a height deviation between holes of the respective metal masks (M) may be measured by measuring the height (H) of the hole of the metal mask (M) using Equation 1.

As set forth, according to the embodiments of the present invention, the 3D measuring device and method have advantages that may detect a height defect of the hole of the metal mask by measuring a height deviation of the hole, detect a defect caused by foreign matter by measuring a surface roughness of the metal mask, and measure whether a defect of the metal mask is present by detecting deformation and a defective position of the hole through the image signal on the surface of the metal mask.

In addition, the 3D measuring device and method have advantages that may emit laser beams having mutually different wavelengths, and more accurately measure a 3D shape using two light sources of which a focal point is aligned with the upper end and the lower end of the metal mask, respectively.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A three-dimensional (3D) measuring device, comprising:
a light source emitting a laser beam;
a focal point adjusting device adjusting a focal position of the laser beam;
a rotating reflection mirror reflecting the laser beam of which the focal position is adjusted by the focal point adjusting device;
a scanning lens disposed on a route of the laser beam so as to scan a measuring target with the laser beam reflected by the rotating reflection mirror;
a condenser lens condensing the laser beam reflected on the measuring target; and
at least one detection unit receiving the laser beam condensed on the condenser lens to thereby detect a laser beam signal.

2. The 3D measuring device according to claim 1, wherein the light source includes a first light source and a second light source which emit laser beams having mutually different wavelengths.

3. The 3D measuring device according to claim 1, wherein the focal point adjusting device includes a first focal point adjusting device and a second focal point adjusting device which align the focal position of the laser beam with one of an upper end portion and a lower end portion of the measuring target.

4. The 3D measuring device according to claim 1, wherein the focal point adjusting device adjusts the focal position of the laser beam in accordance with the laser beam signal detected by the detection unit.

5. The 3D measuring device according to claim 1, wherein the rotating reflection mirror is formed of one of a galvanometer mirror and a polygon mirror.

6. The 3D measuring device according to claim 1, further comprising:
a half reflection mirror selectively transmitting or reflecting the laser beam in accordance with a wavelength of the laser beam.

7. The 3D measuring device according to claim 6, wherein the half reflection mirror includes a first half reflection mirror which is formed between the focal point adjusting device and the rotating reflection mirror, and a second half reflection mirror which is formed between the condenser lens and the detection unit.

8. The 3D measuring device according to claim 6, wherein the half reflection mirror is formed of one of a dichroic mirror and a dichroic filter.

9. The 3D measuring device according to claim 1, wherein the laser beam reflected by the rotating reflection mirror is made to scan a measurement surface of the measuring target while being inclined at a predetermined angle.

10. The 3D measuring device according to claim 1, wherein the scanning lens is an F-theta lens.

11. The 3D measuring device according to claim 1, wherein the detection unit includes a first detection unit and a second detection unit which receive and detect laser beams having mutually different wavelengths.

12. The 3D measuring device according to claim 1, wherein the laser beam signal is image information of the measuring target and illuminance information of the reflected laser beam.

13. The 3D measuring device according to claim 1, further comprising:
a stage moving the measuring target.

14. A 3D measuring method, using a 3D measuring device which includes a light source, a focal point adjusting device, a rotating reflection mirror, a scanning lens, a condenser lens, and a detection unit, comprising:
irradiating a measuring target with a laser beam emitted from the light source while the laser beam is inclined at a predetermined angle;
condensing the laser beam reflected from the measuring target into the condenser lens to receive the condensed laser beam by the detection unit; and
detecting a laser beam signal from the received laser beam.

15. The 3D measuring method according to claim 14, wherein, in the irradiating of the measuring target, the light source includes a first light source and a second light source which have mutually different wavelengths, and the first light source and the second light source align a focal position with an upper end surface or a lower end surface of the measuring target using a first focal point adjusting device and a second focal point adjusting device which are respectively formed in the first light source and the second light source.

16. The 3D measuring method according to claim 14, wherein, in the condensing of the laser beam, the detection unit includes a first detection unit and a second detection unit, and the first detection unit and the second detection unit receive laser beams having mutually different wavelengths.

17. The 3D measuring method according to claim 14, further comprising:
measuring a height of the measuring target through the laser beam signal and a scanning angle of the laser beam irradiated to the measuring target, after the detecting of the laser beam signal.

18. The 3D measuring method according to claim 14, further comprising:
adjusting a focal position of the laser beam in accordance with the laser beam signal, after the detecting of the laser beam signal.
